(19) United States
(12) Patent Application Publication
(10) Pub. No.: US 2011/0002491 A1
(43) Pub. Date: Jan. 6, 2011

(54) HOUSING WITH A HOUSING SHELL FOR A HEARING AID APPLIANCE, HEARING AID APPLIANCE AND PRODUCTION METHOD

(75) Inventors: Harald Klemenz, Furth (DE); Pei Chyi Kristy Lim, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/828,722

(22) Filed: Jul. 1, 2010

(30) Foreign Application Priority Data
Jul. 1, 2009 (DE) 10 2009 031 405.9

(51) Int. Cl. H04R 25/00; H04R 31/00

(52) U.S. Cl. 381/322; 29/594

(57) ABSTRACT

A housing for a hearing aid appliance includes a housing shell which is made, at least in a partial region, from a material which forms a smooth exterior surface in the partial region. Recesses are formed in the material beneath the smooth exterior surface. A material layer located between the recesses and the exterior surface has such a layer thickness that the material layer is at least semitransparent for light, as a result of which the recesses are visible through the material layer when the housing shell is illuminated. A hearing aid appliance having such a housing shell is also provided as well as a method for producing such a housing shell for which a rapid-prototyping process is employed and by which the recesses are produced by not solidifying the starting material there.

### CROSS-REFERENCE TO RELATED APPLICATION

This application claims the priority, under 35 U.S.C. §119, of German Patent Application DE 10 2009 031 405.9, filed Jul. 1, 2009; the prior application is herewith incorporated by reference in its entirety.

### BACKGROUND OF THE INVENTION

### Field of the Invention

The invention relates to a housing with a housing shell for a hearing aid appliance, to a hearing aid appliance having a housing shell of that type and to a method for producing a housing shell of that type.

Hearing aids serve to treat hearing impairments or loss suffered by hearing-impaired persons. In addition to hearing loss, which is also referred to as hard of hearing, hearing impairments in the form of misperceptions which are due, for example, to tinnitus are also treated through the use of hearing aids. Appliances for treating tinnitus can, inter alia, be so-called tinnitus maskers. Although mainly embodiment variants for treating hearing loss are described in the following under the terms hearing aid, hearing aid appliance and hearing aid system, they are equally intended for other appliances for treating hearing impairments to be understood by those terms.

Hearing aid appliances are known that are individually made for a patient. The casing of such hearing aid appliances is, in particular, matched to the patent's anatomy. It is known to employ stereolithography techniques in a production process for an individual casing.

Such appliances or casings are often furnished with information, for example an appliance serial number or brand mark, which enables the appliance to be identified. It is known to engrave that information into the casing's exterior surface with the aid of a laser.

### SUMMARY OF THE INVENTION

It is accordingly an object of the invention to provide a housing with a housing shell for a hearing aid appliance, a hearing aid appliance and a production method, which overcome the hereinafore-mentioned disadvantages of the heretofore-known devices and methods of this general type and in which the housing shell enables a high degree of wearing comfort for a patient as well as a high level of safety.

With the foregoing and other objects in view there is provided, in accordance with the invention, a housing for a hearing aid appliance. The housing comprises a housing shell having at least a partial region made of a material forming a smooth exterior surface in the partial region. The material has recesses formed therein beneath the smooth exterior surface. A material layer is disposed between the recesses and the smooth exterior surface. The material layer has a layer thickness causing the material layer to be at least semitransparent or transparent for light, to permit the recesses to be visible through the material layer upon illuminating the housing shell.

The housing shell has an inside and an outside. The outside forms the exterior surface, which is to say the outwardly-facing surface, in a finished hearing aid appliance in which the housing shell is used. It has been recognized that for a high degree of wearing convenience and a high level of safety, it is important for the exterior surface to be as smooth as possible. When, in the case of known hearing aid appliances, the exterior surface has indentations resulting from engraving information into the exterior surface, that is basically associated with risks for the patient. On one hand, the patient can find the rough exterior surface unpleasant when wearing the hearing aid appliance. On the other hand, the indentations form a possible location where bacteria and other germs can collect. If the information is color-marked as well as engraved, the coloring material will be on the exterior surface. That can cause local irritation and minor allergic reactions depending on the patient's specific susceptibility.

The concept underlying the invention is that a smooth exterior surface can still be combined with a representation of information visibly, if the information is formed through the use of recesses in the material that are visible through the smooth exterior surface. When light penetrates the material layer from outside, it will illuminate the recesses or, as the case may be, their edges and the areas formed by the recesses, which will consequently become visible externally through the material layer.

In accordance with another feature of the invention, the recesses can, in particular, therefore be disposed so as to form legible information. That can, for instance, be a character string, in particular a serial number, or a brand mark of the product or its emblem. In that way, the important information can be integrated into the housing shell in a simple form.

In accordance with a further feature of the invention, the material forming the housing shell is formed, in particular, of a curable plastic. Such material will enable the recesses to be made during the production process itself with no additional process steps during which material is removed again. That will save production time.

In accordance with an added feature of the invention, the layer thickness of the material layer between the recesses and the smooth surface can be less than 1 mm or 0.5 mm, in particular less than 0.3 mm and at most in particular less than 0.2 mm. That layer thickness can be more than 0.03 mm, in particular more than 0.05 mm and at most in particular more than 0.1 mm. The less the thickness of the material layer, the more clearly the recesses can be seen through the material layer, but the more unstable the housing shell will become. The layer thickness can be selected in accordance with the requirements placed on stability and visibility.

With the objects of the invention in view, there is also provided a hearing aid appliance, comprising a housing into which known components, such as a microphone, transducer and loudspeaker are integrated, with the housing being formed at least partially from such a housing shell. Such a housing shell can, for example, form the front plate of a hearing appliance to be worn in an auditory canal.

In accordance with another advantageous feature of the invention, a light source is disposed in the hearing aid appliance, for example an LED lamp, from which light falls onto the housing shell from inside. The light passes through the semitransparent layer to the outside and makes the recesses or, as the case may be, the information formed thereby, particularly clearly visible.

With the objects of the invention in view, there is furthermore provided a method for producing a housing shell for a hearing aid appliance through the use of a rapid-prototyping process. The method comprises producing the housing shell by selectively solidifying a starting material to provide a smooth exterior surface of the housing shell to be formed by using the rapid-prototyping process and leaving recesses in which the starting material is not solidified beneath the smooth exterior surface in the housing shell to be formed.

Producing a housing shell by using the described process is especially advantageous because just one method has to be employed in order to form the housing shell on one hand and to furnish the housing shell with the necessary information on the other hand. It is unnecessary to perform any additional steps such as laser-engraving or applying lettering. The information required to be presented is simply integrated into the housing shell by not solidifying the starting material in specific regions of the housing shell.

In accordance with another mode of the invention, a stereolithography technique by which a curable plastic is selectively cured as the starting material with the aid of a laser source, is advantageously employed as the rapid-prototyping process.

In accordance with a concomitant mode of the invention, the starting material is solidified between the layer with the recesses and the smooth exterior surface with such a layer thickness that the material layer thus created is semitransparent for light, as a result of which the recesses will be visible through the material layer when the housing shell is illuminated. The recesses are spatially disposed so as to form legible information.

The above and following description of the features and of their effect and advantages applies to both the device-specific and the method-specific categories without it being explicitly mentioned separately in each case. Individual features can also be fundamental to the invention in combinations other than those explicitly indicated.

Other features which are considered as characteristic for the invention are set forth in the appended claims.

Although the invention is illustrated and described herein as embodied in a housing with a housing shell for a hearing aid appliance, a hearing aid appliance and a production method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DETAILED DESCRIPTION OF THE SEVERAL VIEWS OF THE DRAWING

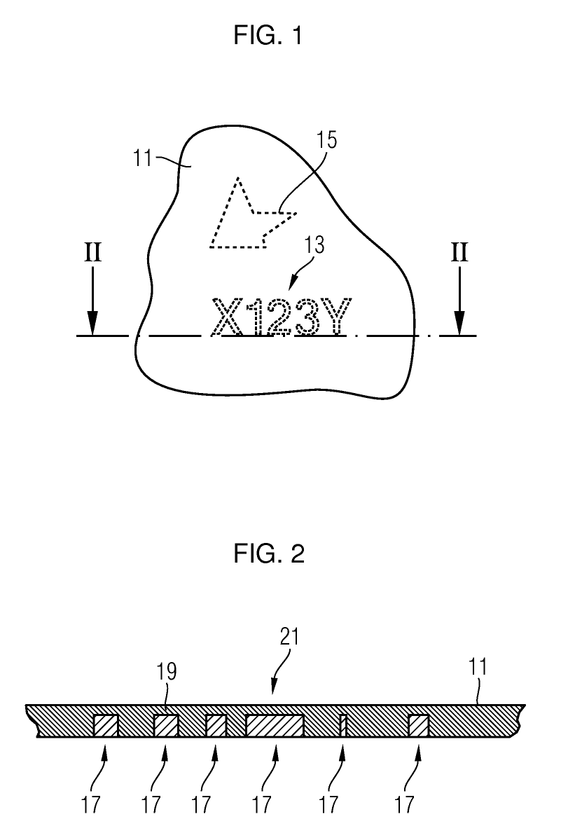

FIG. 1 is a fragmentary, diagrammatic, top-plan view of a housing shell on which a serial number can be seen;

FIG. 2 is a fragmentary, cross-sectional view of the housing shell, which is taken along a line II-II of FIG. 1, in the direction of the arrows;

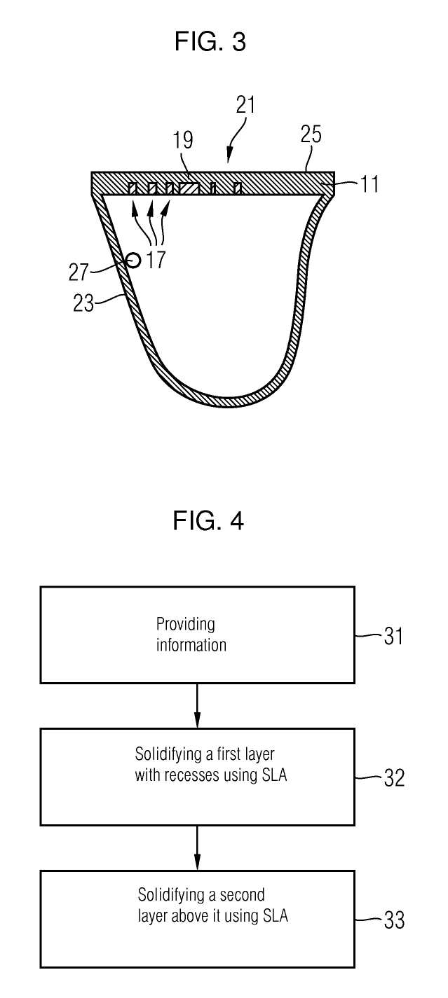

FIG. 3 is a highly diagrammatic, cross-sectional view of a hearing aid appliance having a housing shell as shown in FIGS. 1 and 2, on a reduced scale; and

FIG. 4 is a flow chart containing a representation of steps of the method that are performed when an embodiment variant of the inventive method is implemented.

### DETAILED DESCRIPTION OF THE INVENTION

Referring now to the figures of the drawings in detail and first, particularly, to FIG. 1 thereof, there is seen a top view of an exterior surface of a housing shell 11 or a part thereof. Information can be seen through a smooth exterior surface. The information can, for example, be a character string 13 corresponding to a serial number or an emblem 15 of a brand mark.

FIG. 2 is a cross section through the housing shell 11 which is taken along a line II-II in FIG. 1. It can be seen that the housing shell 11 is made of a material that has recesses 17 at specific locations. The recesses 17 correspond to the character string shown in FIG. 1. A material layer 19, which is located between the recesses 17 and an exterior surface 21 of the housing shell 11, has a layer thickness dimensioned in such a way that the intermediate layer 19 is semitransparent or transparent for visible light.

FIG. 3 is a highly diagrammatic sectional view through a hearing appliance 23 having a front plate 25 that is formed by such a housing shell 11. For the sake of clarity, none of the components that are customary for a hearing appliance 23 are shown.

An LED lamp 27, that is additionally integrated into the hearing appliance 23, can be activated by a user in such a way that the LED lamp 27 emits light from the inside to the outside. The light emitted by the LED lamp 27 passes through the front plate 25 and illuminates the recesses 17. A user viewing the front plate 25 from the outside will be able to read the information displayed in the recesses 17.

The use of a lamp 27 inside the hearing appliance 23 is, however, not mandatory. Ambient light may by itself suffice to externally illuminate the recesses 17 through the intermediate layer 19 and render them visible.

FIG. 4 illustrates the steps of the method that can be performed when such a housing shell is produced.

First, the information that should be integrated into the housing shell to be produced is provided (step 31). A first material layer is then solidified with the aid of a stereolithography (SLA) technique, with recesses in which the starting material is not solidified being left in the material layer, specifically in such a way that the information provided will be formed by the recesses (step 32). A layer is then solidified that is located above the layer with the recesses and which is completely solidified (step 33). A smooth exterior surface will be formed thereby. The housing shell can be matched to a patient's individual anatomy during the production process.

1. A housing for a hearing aid appliance, the housing comprising:
a housing shell having at least a partial region made of a material forming a smooth exterior surface in said partial region;
said material having recesses formed therein beneath said smooth exterior surface; and
a material layer disposed between said recesses and said smooth exterior surface, said material layer having a layer thickness causing said material layer to be at least semitransparent for light, to permit said recesses to be visible through said material layer upon illuminating said housing shell.

2. The housing according to claim 1, wherein said recesses form legible information.

3. The housing according to claim 2, wherein said recesses form a character string as said legible information.

4. The housing according to claim 3, wherein said character string is a serial number.

5. The housing according to claim 1, wherein said material is formed of a curable plastic.

6. The housing according to claim 1, wherein said material layer has a layer thickness of less than 0.5 mm.

7. The housing according to claim 1, wherein said material layer has a layer thickness of less than 0.3 mm.

8. The housing according to claim 1, wherein said material layer has a layer thickness of less than 0.2 mm.

9. A hearing aid appliance, comprising:
a housing according to claim 1 formed at least partially with a housing shell, for receiving components of the hearing aid appliance to be integrated therein.

10. The hearing aid appliance according to claim 9, which further comprises a light source disposed within the hearing aid appliance for emitting light to pass through said partial region of said housing shell to the outside for making said recesses in said housing shell externally visible.

11. A method for producing a housing shell for a hearing aid appliance through the use of a rapid-prototyping process, the method comprising the following steps:
producing the housing shell by selectively solidifying a starting material to provide a smooth exterior surface of the housing shell to be formed by using the rapid-prototyping process and leaving recesses in which the starting material is not solidified beneath the smooth exterior surface in the housing shell to be formed.

12. The method according to claim 11, which further comprises solidifying the starting material between the recesses and the smooth exterior surface with a layer thickness creating a material layer being semitransparent for light and permitting the recesses to be visible through the material layer when the housing shell is illuminated.

13. The method according to claim 11, which further comprises forming legible information with the recesses.

14. The method according to claim 11, which further comprises forming a character string with the recesses.

15. The method according to claim 11, which further comprises forming a serial number with the recesses.

16. The method according to claim 11, which further comprises using a stereolithography technique as the rapid-prototyping process.
